(19) United States
(12) Patent Application Publication
(10) Pub. No.: US 2021/0115887 A1
(43) Pub. Date: Apr. 22, 2021

(54) FUEL INJECTION VALVE

(71) Applicant: Hitachi Automotive Systems, Ltd., Hitachinaka-shi, Ibaraki (JP)

(72) Inventor: Yasuo MIZOBUCHI, Hitachinaka (JP)

(73) Assignee: Hitachi Automotive Systems, Ltd., Hitachinaka-shi, Ibaraki (JP)

(21) Appl. No.: 17/051,889

(22) PCT Filed: Jul. 12, 2019
(86) PCT No.: PCT/JP2019/027637

§ 371 Date: Oct. 30, 2020

(30) Foreign Application Priority Data
Jul. 24, 2018 (JP) 2018-138141

(51) Int. Cl. F02M 51/06

(52) U.S. Cl. CPC F02M 51/0671; F02M 61/18; F02M 51/0685

(57) ABSTRACT

Provided is a fuel injection valve capable of correcting an eccentricity of a valve body. For this reason, a fuel injection valve 100 includes a valve body 101; a mover 201 that drives the valve body 101; a fixed core 107 (magnetic core) that attracts the mover 201; and a flow path 107D-133F (magnetic core downstream flow path) representing a flow path that is formed on a downstream side of the fixed core 107. The mover 201 includes an upstream flow path 201C (mover upstream flow path) representing a flow path that is connected to the flow path 107D-133F to allow fuel to flow downstream. The radial lengths (L21 and L22) of an overlap between a downstream opening surface of the flow path 107D-133F and an upstream opening surface of the upstream flow path 201C are smaller than the radial lengths (L11 and L12) of the flow path 107D-133F.

### TECHNICAL FIELD

The present invention relates to a fuel injection valve.

### BACKGROUND ART

As a background art of the technical field, there is known a fuel injection valve described in JP 2016-118208 A (PTL 1). In order to provide a fuel injection valve capable of changing the fuel injection rate with a simple structure, the summary of PTL 1 describes the fuel injection valve including a fixed core, a needle, a movable core, and a coil that generates electromagnetic attraction force between the needle, the movable core, and the magnetic core.

The needle includes a needle large diameter portion having a larger outer diameter than that of a main body made of a magnetic material. The movable core is provided on a valve seat side of the fixed core so as to be reciprocable together with the needle in a housing in a state where the needle large diameter portion is located inside a large diameter inner wall surface and the main body is located inside a small diameter inner wall surface. The movable core is formed such that when a seal portion and a valve seat are in contact with each other, a distance between a second step surface of the needle and an end surface on the valve seat side of the fixed core is longer than a distance between an end surface on a side opposite the valve seat and an end surface of the fixed core.

### CITATION LIST

### Patent Literature

PTL 1: JP 2016-118208 A

### SUMMARY OF INVENTION

### Technical Problem

In the fuel injection valve disclosed in PTL 1, during reciprocation, due to a space (clearance) of a portion sliding against a peripheral component such as the fixed core or the valve seat, the needle (valve body) or the movable core which is a movable portion is inclined or becomes eccentric to make the movement of a needle 40 be unstable in each injection operation, and thus there occurs a variation in flow rate of fuel injected from an injection hole 311 when a valve seat 312 and a seal portion 42 are separated from each other.

An object of the present invention is to provide a fuel injection valve capable of correcting an eccentricity of a valve body.

### Solution to Problem

In order to achieve the above object, according to an aspect of the present invention, there is provided a fuel injection valve including: a valve body; a mover that drives the valve body; a magnetic core that attracts the mover; and a magnetic core downstream flow path representing a flow path that is formed on a downstream side of the magnetic core. The mover includes a mover upstream flow path representing a flow path that is connected to the magnetic core downstream flow path to allow fuel to flow downstream. A radial length of an overlap between a downstream opening surface of the magnetic core downstream flow path and an upstream opening surface of the mover upstream flow path is smaller than a radial length of the magnetic core downstream flow path.

### Advantageous Effects of Invention

According to the present invention, an eccentricity of the valve body can be corrected. Problems, configurations, and effects other than those described above will become apparent from the following description of embodiments.

### BRIEF DESCRIPTION OF DRAWINGS

FIG. 1 is a cross-sectional view illustrating a structure of a fuel injection valve according to embodiments of the present invention.

FIG. 2 is an enlarged view of the vicinity of a mover of the fuel injection valve according to a first embodiment of the present invention, and is a cross-sectional view illustrating a state where a coil is deenergized.

FIG. 3 is a cross-sectional view illustrating a state where the coil comes into an energized state from the state of FIG. 2, so that the mover moves in a valve opening direction and an upper end surface of the mover collides with a lower surface of a step portion of a valve body.

FIG. 4 is a cross-sectional view illustrating a state where the mover is further displaced from the state of FIG. 3, so that the upper end surface of the mover collides with a lower end surface of a fixed core.

FIG. 5 is an enlarged view of the vicinity of a connection portion between fuel flow paths of the fixed core and the mover of the fuel injection valve according to the first embodiment of the present invention, and is an enlarged view when the axis of the mover is not misaligned.

FIG. 6 is an enlarged view of the vicinity of the connection portion between the flow paths of the fixed core and the mover of the fuel injection valve according to the first embodiment of the present invention, and is an enlarged view when the axis of the mover is misaligned in a rightward direction.

FIG. 7A is an enlarged cross-sectional view illustrating a simulation result (flow speed) when the same state as that of FIG. 6 is simulated, and illustrating the vicinity of the mover of the fuel injection valve.

FIG. 7B is an enlarged cross-sectional view illustrating a simulation result (pressure) when the same state as that of FIG. 6 is simulated, and illustrating the vicinity of the mover of the fuel injection valve.

FIG. 8 is an enlarged view of the vicinity of a mover of a fuel injection valve according to a second embodiment of the present invention, and is a cross-sectional view illustrating a state where a coil is deenergized.

FIG. 9 is an enlarged view of the vicinity of a connection portion between fuel flow paths of a fixed core and the mover of the fuel injection valve according to the second embodiment of the present invention, and is an enlarged view when the axis of the mover is not misaligned.

FIG. 10 is an enlarged view of the vicinity of the connection portion between the flow paths of the fixed core and the mover of the fuel injection valve according to the second embodiment of the present invention, and is an enlarged view when the axis of the mover is misaligned in the rightward direction.

FIG. 11 is a perspective view of the mover used in the fuel injection valves according to the first and second embodiments of the present invention.

FIG. 12 is a perspective view of the mover, which is used in the fuel injection valves according to the first and second embodiments of the present invention, as seen in another direction.

### DESCRIPTION OF EMBODIMENTS

Hereinafter, embodiments of the present invention will be described with reference to the drawings. An object of the present embodiments is to provide a fuel injection valve that can use fluid force, which is applied in a direction to correct the inclination or eccentricity of a valve body, to stabilize the behavior of the valve.

### First Embodiment

In the present embodiment, an electromagnetic fuel injection valve will be described as a first embodiment of the fuel injection valve.

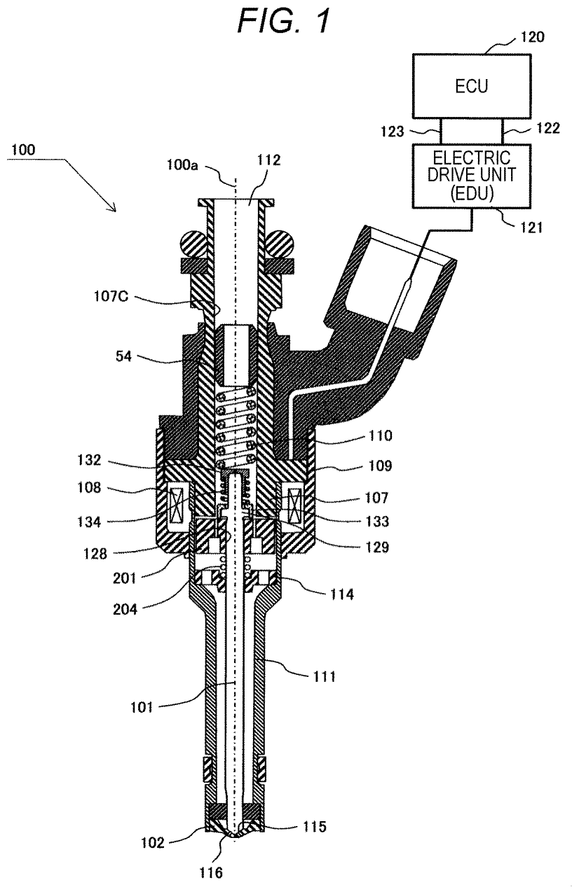

In addition, the electromagnetic fuel injection valve of FIG. 1 is an example of an electromagnetic fuel injection valve for an in-cylinder direct injection gasoline engine; however, the present invention is also applicable to an electromagnetic fuel injection valve for a port injection gasoline engine.

In addition, the present invention is not limited to the electromagnetic fuel injection valve, and is also applicable to a fuel injection valve driven by a piezoelectric element or a magnetostrictor. The effects of the present invention are also effective in the electromagnetic fuel injection valve for a port injection gasoline engine or the fuel injection valve driven by a piezoelectric element or a magnetostrictor.

Incidentally, a description will be given based on the assumption that a fuel injection hole 116 side is a downstream side and a fuel supply port 112 side is an upstream side in a direction along a central axis 100a (central line) of a fuel injection valve 100. In addition, in the description, for example, an upward and downward direction such as an “upper end surface” or a “lower end surface” may be specified, and the upward and downward direction is based on an upward and downward direction of each of the drawings, and does not specify an upward and downward direction of the fuel injection valve in a mounted state.

FIG. 1 is a cross-sectional view illustrating the structure of the fuel injection valve 100 according to an embodiment of the present invention.

The fuel injection valve 100 is driven by an electric drive unit (EDU) 121 and an engine control unit (ECU) 120. A drive device of the fuel injection valve 100 is a device that generates the drive voltage of the fuel injection valve 100, and corresponds to the EDU 121 of FIG. 1. The EDU 121 may be integrated with the ECU 120.

The ECU 120 takes signals indicating a state of an engine (internal combustion engine) from various sensors, and performs computation of an appropriate drive pulse width or injection timing according to operating conditions of the engine. A drive pulse output from the ECU 120 is input to the EDU 121 of the fuel injection valve 100 through a signal line 123.

The EDU 121 controls voltage to be applied to a coil 108 to supply a current to the coil 108. The ECU 120 communicates with the EDU 121 through a communication line 122, and can switch the drive current that is generated by the EDU 121 according to the pressure of fuel to be supplied to the fuel injection valve 100 or operation conditions. The EDU 121 can change a control constant through communication with the ECU 120, and changes a current waveform according to the control constant.

The entire configuration and the flow of the fuel in the fuel injection valve 100 will be described.

A fuel supply port 112 is provided in an upper end portion of the fuel injection valve 100, and a fuel injection hole 116 is provided in a lower end portion of the fuel injection valve 100. The fuel is supplied from the fuel supply port 112 into the fuel injection valve 100 to flow from the upper end portion of the fuel injection valve 100 toward the lower end portion in the direction along the central axis 100a and to be injected from the fuel injection hole 116.

Inside the fuel injection valve 100, a valve body 101 that opens and closes a fuel flow path is provided, and a valve seat member 102 is provided at a position to face the valve body 101. The fuel injection hole 116 and a valve seat 115 are formed in the valve seat member 102. The valve body 101 comes into contact with the valve seat 115 to form a seal portion. The valve body 101 has a structure where when the coil 108 is not energized, the valve body 101 is pressed against the valve seat 115 by a first spring 110 to seal the fuel. Namely, the valve body 101 and the valve seat 115 collaborate to open and close a fuel passage leading to the fuel injection hole 116.

The fuel injection valve 100 includes a mover 201 (movable core), a fixed core 107 (magnetic core), and the coil 108 as a drive unit of the valve body 101. In other words, the mover 201 drives the valve body 101. The mover 201, the fixed core 107, and a yoke 109 form a magnetic circuit. The coil 108 is disposed on an outer peripheral side of the fixed core 107, and the yoke 109 is disposed to cover an outer peripheral side of the coil 108. Magnetic attraction force (electromagnetic attraction force) is generated between the mover 201 and the fixed core 107 by the energization of the coil 108 to drive the valve body 101 in a valve opening direction. Namely, the fixed core 107 (magnetic core) attracts the mover 201.

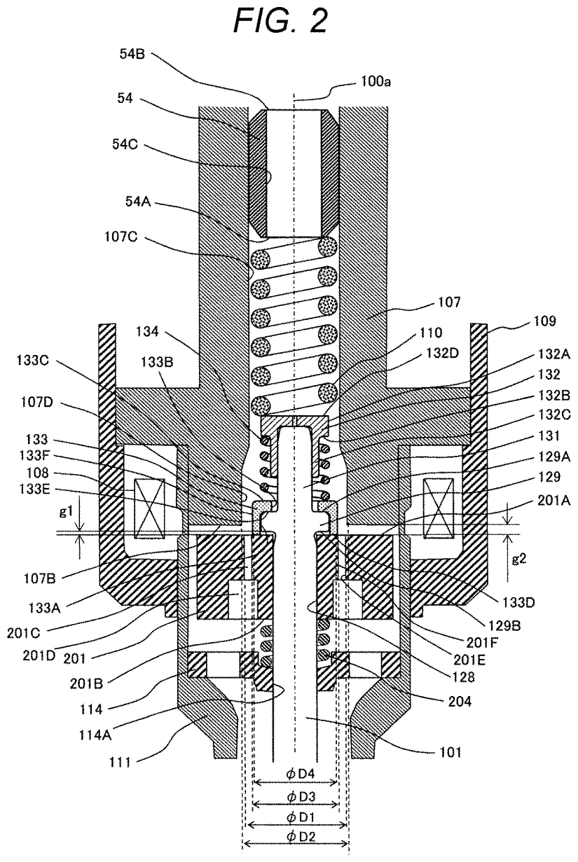

The fixed core 107 and the mover 201 are disposed such that an upper end surface 201A (refer to FIG. 2) which is an end surface on the fuel supply port 112 side of the mover 201 faces a lower end surface 107B (refer to FIG. 2) which is an end surface on a valve seat 115 side of the fixed core 107. The magnetic attraction force is applied between the upper end surface 201A of the mover 201 and the lower end surface 107B of the fixed core 107.

The mover 201 may be referred to as a movable core with respect to the fixed core 107.

In the present embodiment, the mover 201, the fixed core 107, and the coil 108 are formed as an electromagnetic drive unit. The drive unit of the fuel injection valve 100 may be a drive unit formed of a piezoelectric element, a magnetostrictor, or the like.

The valve body 101 and the mover 201 are encapsulated in a nozzle holder 111, which is formed of a cylindrical member, to form a movable portion. The valve body 101 and the mover 201 are independently formed of separate bodies. Namely, the mover 201 and the valve body 101 are formed as different members, and the valve body 101 is configured to be relatively displaceable with respect to the mover 201 in a valve opening and closing direction. Incidentally, the displacement of the mover 201 with respect to the valve body 101 in the valve opening direction is restricted by a step portion 129 of the valve body 101.

The valve body 101 is inserted into a through-hole 128 formed in a central portion in a radial direction (direction perpendicular to the central axis 100a) of the mover 201, and the step portion 129 is provided in the vicinity of an end portion on a fixed core 107 side of the valve body 101. Namely, the valve body 101 includes the step portion 129 (flange portion) that engages with the mover 201.

When a valve opening and closing operation is performed, the step portion 129 engages with the mover 201, so that the valve body 101 and the mover 201 integrally move together. In a state where the step portion 129 is not engaged with the mover 201, the valve body 101 and the mover 201 are independently configured to be relatively displaceable with respect to each other in the direction along the central axis 100a (valve opening and closing direction).

A cap 132 is attached to an upper end of the valve body 101, and an upper end surface 132D (refer to FIG. 2) of the cap 132 is in contact with a lower end portion of the first spring 110. The first spring 110 in a compressed state is provided between an adjuster 54 and the cap 132, and the valve body 101 is biased in a downstream direction (valve closing direction) by the first spring 110.

Since the first spring 110 biases the valve body 101 in the valve closing direction, the first spring 110 may be referred to as a valve closing spring. The adjuster 54 is press-fitted into and fixed to a through-hole 107C of the fixed core 107 to adjust the fixation position in the direction along the central axis 100a and thus to adjust the biasing force of the first spring 110 with respect to the valve body 101.

In addition, in the present embodiment, in order to enable preliminary lift of the valve body 101, a second spring 134 (intermediate spring) and an intermediate member 133 are provided between the cap 132 and both the mover 201 and the step portion 129. In other words, in a valve closed state, the intermediate member 133 forms a gap between the step portion 129 (flange portion) and the mover 201.

The preliminary lift is an operation in which the mover 201 starts moving (being lifted) in the valve opening direction in a state where the valve body 101 remains closed during opening of the valve. The preliminary lift will be described in detail later.

Incidentally, a third spring 204 (zero spring) in a compressed state is provided between a spring holding member 114 and the mover 201 that are provided in the nozzle holder 111. The mover 201 is biased in the valve opening direction by the third spring 204.

When a drive current flows from the EDU 121 to the coil 108, magnetic attraction force is generated between the fixed core 107 and the mover 201. As will be described in detail later, when the mover 201 moves toward the fixed core 107, the mover 201 engages with the valve body 101 to lift the valve body 101, so that the fuel injection valve 100 is opened.

Here, a configuration when the valve body 101 is in a valve closed state will be described in detail with reference to FIG. 2. FIG. 2 is an enlarged view of the vicinity of the mover 201 of the fuel injection valve 100 according to the first embodiment of the present invention, and is a cross-sectional view illustrating a state where the coil 108 is deenergized. Incidentally, although not illustrated in FIG. 2, the valve body 101 is in contact with the valve seat 115, so that the valve body 101 is in a valve closed state.

A head including the step portion 129 of which the outer diameter is largest in the valve body 101 is provided in an end portion on an opposite side of the valve body 101 from a valve seat 115 side. The step portion 129 forms a flange portion (enlarged diameter portion) that extends out in a flange shape from an outer peripheral surface of the valve body 101. A protruding portion 131 having a smaller diameter than the outer diameter of the step portion 129 is provided upward from an upper surface 129A (upper end surface) of the step portion 129, and the cap 132 provided with the upper end surface 132D which is a seating surface of the first spring 110 (valve closing spring) is provided in an upper end portion of the protruding portion 131. The cap 132 is press-fitted and fixed to the protruding portion 131.

The through-hole 128 through which the valve body 101 penetrates is provided at the center of the mover 201. The spring holding member 114 is attached to the nozzle holder 111. The third spring 204 (zero spring) is attached between the mover 201 and the spring holding member 114.

Specifically, one end portion of the third spring 204 is supported by a main body side (in the present embodiment, the spring holding member 114 attached to the nozzle holder 111) of the fuel injection valve 100, and the other end portion of the third spring 204 is in contact with a lower end surface 201B of the mover 201, so that the third spring 204 biases the mover 201 in the valve opening direction (direction to be pulled away from the spring holding member 114). Namely, the third spring 204 is disposed on an opposite side of the mover 201 from the fixed core 107 side to bias the mover 201 in the valve opening direction.

The biasing force (set load) of the third spring 204 is applied to the mover 201 in a direction opposite the biasing force (set load) of the first spring 110. Namely, the first spring 110 biases the valve body 101 in the valve closing direction, and the third spring 204 (zero spring) biases the mover 201 from the side opposite the fixed core 107 side in the valve opening direction. Incidentally, one end portion of the first spring 110 is supported by a main body side (in the present embodiment, a lower end surface 54A of the adjuster 54) of the fuel injection valve 100.

The intermediate member 133 is provided on an upper end surface 201A side of the mover 201. A recess portion 133A is formed upward on a lower end surface 133D side (lower surface side) of the intermediate member 133, and the recess portion 133A has a diameter (inner diameter) and a depth such that the step portion 129 of the valve body 101 is fitted into the recess portion 133A.

Namely, the diameter (inner diameter) of the recess portion 133A is larger than the diameter (outer diameter) of the step portion 129, and the depth of the recess portion 133A is larger than a length between the upper surface 129A and a lower surface 129B of the step portion 129. Incidentally, a length obtained by subtracting the height (interval) between the upper surface 129A and the lower surface 129B of the step portion 129 from the depth of the recess portion 133A of the intermediate member 133 is the length of a gap g1.

A through-hole 133B through which the protruding portion 131 of the valve body 101 penetrates is formed in a bottom surface 133E (bottom portion) of the recess portion 133A. The second spring 134 (intermediate spring) is held between the intermediate member 133 and the cap 132, and an upper end surface 133C of the intermediate member 133 forms a spring seat with which one end portion of the second spring 134 is in contact.

The biasing force of each of the springs 204 and 134 is set such that the absolute value of a biasing force Fz of the third spring 204 (zero spring) is smaller than the absolute value of a biasing force Fm of the second spring 134 (intermediate spring). For this reason, the second spring 134 biases the mover 201 from the fixed core 107 side in the valve closing direction (to the valve seat 115 side) via the intermediate member 133.

As a result, in the state of FIG. 2, the bottom surface 133E of the recess portion 133A of the intermediate member 133 is brought into contact with the upper surface 129A of the step portion 129 of the valve body 101, the lower end surface 133D of the intermediate member 133 is brought into contact with the upper end surface 201A of the mover 201, and the lower surface 129B of the step portion 129 of the valve body 101 is separated from the upper end surface 201A of the mover 201, so that the gap g1 is present between the lower surface 129B and the upper end surface 201A. The gap g1 enables the movement of the mover 201 in the preliminary lift.

In the present embodiment, in order to enable the preliminary lift, the valve body 101 includes the step portion 129, the intermediate member 133, and the second spring 134. The step portion 129 comes into a contact with a contact portion (upper end surface 201A) of the mover 201 from the fixed core 107 side to restrict the relative displacement of the mover 201 to the fixed core 107 side. The intermediate member 133 forms the gap g1 between the contact portion (upper end surface 201A) of the mover 201, which comes into contact with the step portion 129, and a contact portion (lower surface 129B) of the step portion 129, which comes into contact with the mover 201. The second spring 134 biases the intermediate member 133 in the valve closing direction. The intermediate member 133 and the second spring 134 are integrally assembled to the valve body 101.

In the present embodiment, the lower end surface 107B of the fixed core 107 forms a mover displacement restriction portion that restricts the mover 201 from being displaced in the valve opening direction (upstream direction). During closing of the valve, a length (distance) g2 of a gap between the upper end surface 201A of the mover 201 and the lower end surface 107B (mover displacement restriction portion) of the fixed core 107 is set to be larger than the gap g1 that is present between the lower surface 129B of the step portion 129 of the valve body 101 and the upper end surface 201A of the mover 201.

A flange portion 132A that extends out in the radial direction is formed in an upper end portion of the cap 132 located above the intermediate member 133, and a lower end surface 132B of the flange portion 132A forms a spring seat with which the other end portion of the second spring 134 is in contact. A cylindrical portion 132C is formed downward from the lower end surface 132B of the flange portion 132A of the cap 132, and the protruding portion 131 is press-fitted into and fixed to the cylindrical portion 132C.

Since each of the cap 132 and the intermediate member 133 forms the spring seat of the second spring 134, the diameter (inner diameter) of the through-hole 133B of the intermediate member 133 is smaller than the diameter (outer diameter) of the flange portion 132A of the cap 132. Therefore, the intermediate member 133 and the second spring 134 are assembled to the valve body 101 before a step of press-fitting the cap 132 and the protruding portion 131.

In the present embodiment, the first spring 110, the second spring 134, and the third spring 204 are formed of coil springs, and are disposed in the same row (one row) in the direction along the central axis 100a of the fuel injection valve 100.

Accordingly, an increase in radial dimension of the fuel injection valve 100 can be suppressed.

The fuel flowing from upstream of the fixed core 107 flows downstream through the through-hole 107C. A cylindrical inner diameter 107D concentric with the through-hole 107C is provided on a downstream side of the fixed core 107. The cylindrical inner diameter 107D is smoothly connected to the through-hole 107C, so that a flow path 107D-133F is formed between the cylindrical inner diameter 107D and an outermost surface 133F of the intermediate member 133.

Here, the flow path 107D-133F may be referred to as a magnetic core downstream flow path representing a flow path that is formed on the downstream side of the fixed core 107 (magnetic core). In the present embodiment, the flow path 107D-133F (magnetic core downstream flow path) is formed between an outer diameter portion of the valve body 101 and an inner diameter portion of the fixed core 107 (magnetic core). In other words, the flow path 107D-133F (magnetic core downstream flow path) is formed between the step portion 129 (flange portion) and the fixed core 107 (magnetic core). For details, the flow path 107D-133F (magnetic core downstream flow path) is formed between an outer peripheral surface of the intermediate member 133 and an inner peripheral surface of the fixed core 107 (magnetic core). Accordingly, an annular flow path is formed on the downstream side of the fixed core 107 (magnetic core).

The cylindrical inner diameter 107D that is a downstream inner diameter of the fixed core 107 (magnetic core) is larger than the through-hole 107C (upstream inner diameter of the magnetic core). Accordingly, for example, while an axis misalignment of the first spring 110 is suppressed by the through-hole 107C, the cross-sectional area of the flow path 107D-133F (magnetic core downstream flow path) can be secured. The through-hole 107C is formed in a central axis direction of the fixed core 107 (magnetic core).

The fuel flows through the flow path 107D-133F, which is formed by the outermost surface 133F of the intermediate member 133 and the cylindrical inner diameter 107D, to a mover side. In this case, in FIG. 2, the through-hole 107C and the cylindrical inner diameter 107D of the fixed core 107 are illustrated as surfaces having different diameters, but may be surfaces having the same diameter. In addition, since the flow path 107D-133F is formed of the cylindrical inner diameter 107D and the outermost surface 133F of the intermediate member 133, the flow path 107D-133F is an annular flow path as seen in an axial direction.

An upstream flow path 201C of the mover 201, which forms the same annular flow path as the flow path 107D-133F having an annular shape, is provided in the upper end surface 201A of the mover 201 (refer to FIG. 11).

Here, the upstream flow path 201C may be referred to as a mover upstream flow path representing a flow path that is connected to the flow path 107D-133F (magnetic core downstream flow path) to allow the fuel to flow downstream. The upstream flow path 201C (mover upstream flow path) is formed of a recess portion that is formed in an annular shape in the mover 201 and is recessed downstream. Accordingly, the fuel flows rotationally symmetrically with respect to the central axis 100a from the flow path 107D-133F (magnetic core downstream flow path) to the upstream flow path 201C (mover upstream flow path).

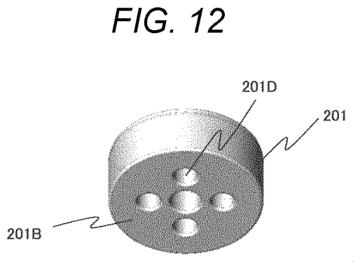

The upstream flow path 201C of the mover 201 faces the flow path 107D-133F that has an annular shape and is formed on the downstream side of the fixed core 107. A downstream side of the upstream flow path 201C of the mover 201 is connected to a communication hole 201D (refer to FIG. 12), which is provided in the lower end surface 201B of the mover 201, to form a flow path in the mover 201.

Namely, the mover 201 is provided with the communication hole 201D (mover downstream flow path) that is connected to a downstream opening surface of the upstream flow path 201C (mover upstream flow path) and has an upstream opening surface having a larger cross-sectional area than that of the downstream opening surface of the upstream flow path 201C (mover upstream flow path). A plurality of the communication holes 201D (mover downstream flow path) are formed in a cylindrical shape in the mover 201. Since the communication hole 201D has a cylindrical shape, for example, the machining is facilitated.

The relationship between the upstream flow path 201C and the communication hole 201D is as follows. The communication hole 201D is formed of a plurality of communication holes. Since the cross-sectional area of the communication hole 201D is larger than that of the downstream opening surface of the upstream flow path 201C, the fuel flowing through the upstream flow path 201C can flow smoothly downstream.

A diameter φD1 of an inward surface 201E on a radial outer side of the upstream flow path 201C of the mover 201 is set to be smaller than a diameter φD2 of the cylindrical inner diameter 107D of the fixed core 107, and a diameter φD3 of an outward surface 201F on a radial inner side of the upstream flow path 201C of the mover 201 is set to be larger than a diameter φD4 of the outermost surface 133F of the intermediate member 133.

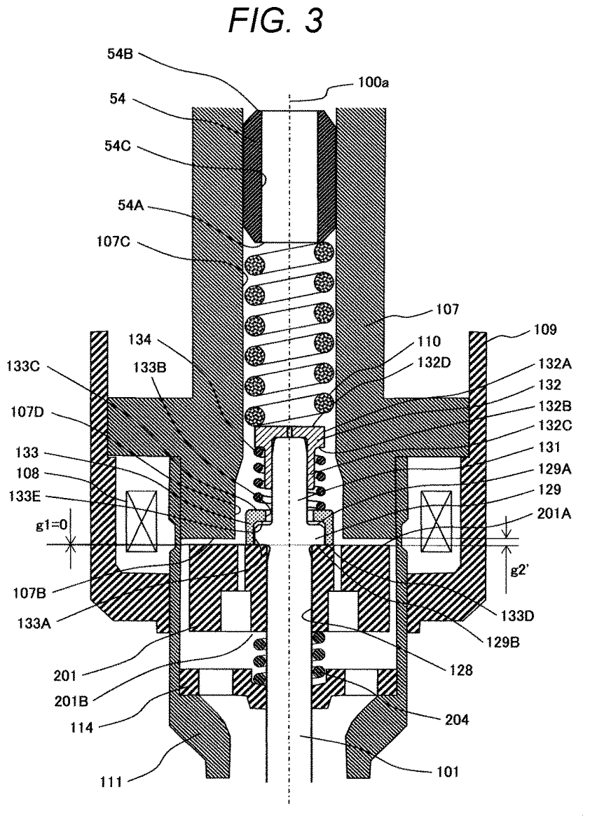

An initial movement state of the mover 201 during opening of the valve will be described with reference to FIG. 3.

FIG. 3 is a cross-sectional view illustrating a state where the coil 108 comes into an energized state from the state of FIG. 2, so that the mover 201 moves in the valve opening direction and the upper end surface 201A of the mover 201 collides with the lower surface 129B of the step portion 129 of the valve body 101.

When the coil 108 is energized from the state of FIG. 2, magnetic fluxes are generated in the fixed core 107, the yoke 109, and the mover 201 which form a magnetic circuit, so that magnetic attraction force is generated between the fixed core 107 and the mover 201.

Equation (1) represents a relationship between a magnetic attraction force Fa, the biasing force Fm of the second spring 134 (intermediate spring), and the biasing force Fz of the third spring 204 (zero spring) when the mover 201 starts moving in the valve opening direction.

[Mathematical Equation 1]

Fa>Fm−Fz (1)

As illustrated in Equation (1), when the magnetic attraction force Fa applied between the mover 201 and the fixed core 107 is larger than a difference between the biasing force Fm of the second spring 134 and the biasing force Fz of the third spring 204, the mover 201 is attracted to the fixed core 107 side to start moving in the valve opening direction.

FIG. 3 illustrates a state where the mover 201 is displaced by the gap g1 to the fixed core 107 side in a state where the valve body 101 maintains a valve closed state. Namely, the mover 201 lifts the intermediate member 133, and the upper end surface 201A of the mover 201 comes into contact with the lower surface 129B of the step portion 129 of the valve body 101. At this time, a gap corresponding to the gap g1 is formed between the bottom surface 133E of the intermediate member 133 and the upper surface 129A of the step portion 129. In FIG. 2, a gap g2 is present between the fixed core 107 and the upper end surface 201A of the mover 201, but in FIG. 3, the gap is reduced to g2′ (g2′=g2−g1).

At this time, kinetic energy accumulated in the mover 201 is used for the valve opening operation of the valve body 101. As a result, since the gap g1 (preliminary lift) is set, the kinetic energy of the mover 201 can be used, and the responsiveness of the valve opening operation can be improved. Therefore, the valve can be quickly opened even under high fuel pressure.

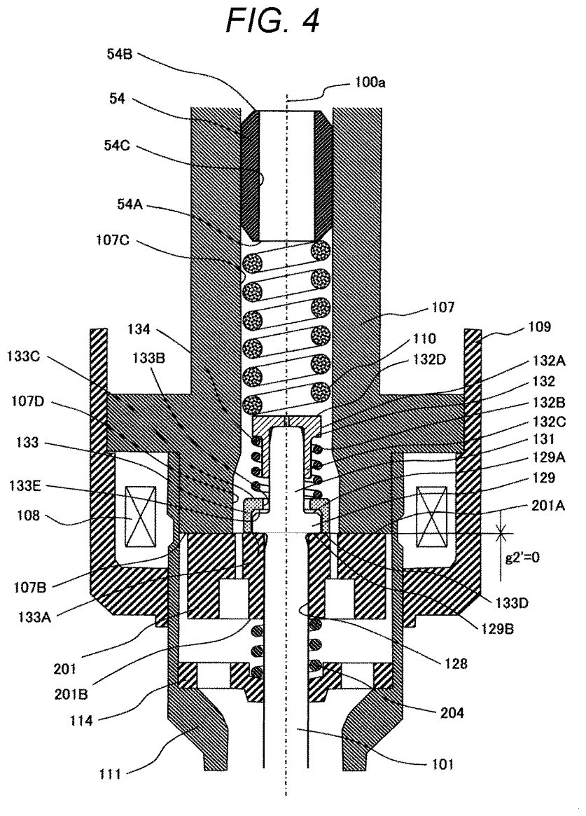

FIG. 4 is a cross-sectional view illustrating a state where the mover 201 is further displaced from the state of FIG. 3, so that the upper end surface 201A of the mover 201 collides with the lower end surface 107B of the fixed core 107.

In FIG. 4, the upper end surface 201A of the mover 201 collides with the lower end surface 107B of the fixed core 107, so that the valve body 101 is restricted from moving in the upstream direction. As a result, the valve body 101 is lifted by a distance (g2−g1) corresponding to a gap g2′.

In the fuel injection valve 100, in order to enable smooth reciprocation of the valve body 101 or the mover 201 which is a movable portion, a clearance is provided between each component and a peripheral component. For example, a clearance is provided between a through-hole 114A (refer to FIG. 2) of the spring holding member 114 and the valve body 101, and between the through-hole 128 (refer to FIG. 2) of the mover 201 and the valve body 101. Although not illustrated in the drawing, a clearance is also provided at a location where the valve body 101 slides against a peripheral component on a side close to the valve seat 115.

For this reason, the inclination or eccentricity of the valve body 101 or the mover 201 is allowed within the range of the above clearance, so that the axis of the valve body 101 or the mover 201 is misaligned from the central axis 100a of the fuel injection valve. In the valve closed state of FIG. 2, due to an offset or the like of the biasing force of the first spring 110, the valve body 101 or the mover 201 is assembled in a state where the central axis of the valve body 101 or the mover 201 is misaligned from the central axis 100a.

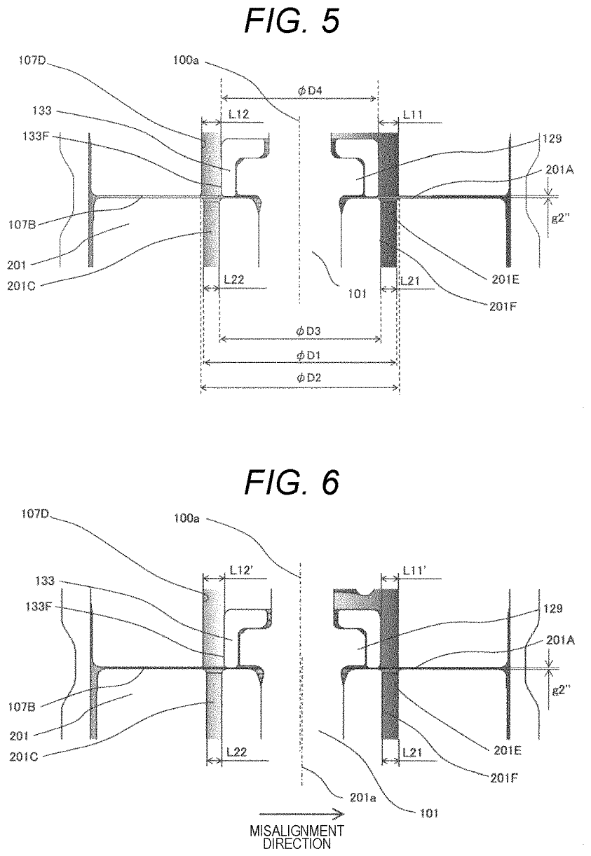

Here, FIGS. 5 and 6 illustrate enlarged cross-sectional views of the downstream side of the fixed core 107, an upstream side of the mover 201, and the vicinity of the intermediate member 133 and the valve body 101.

FIG. 5 illustrates a positional relationship between the components when the mover 201 lifts the valve body 101, so that the clearance between the lower end surface 107B of the fixed core 107 and the upper end surface 201A of the mover 201 becomes g2″ (g2′>g2″>0), and an axis misalignment does not occur.

In this state, regarding the flow path 107D-133F on the downstream side of the fixed core 107, radial lengths L11 and L12 of right and left flow paths with respect to the central axis 100a are equal. In addition, radial lengths L21 and L22 of right and left flow paths of the upstream flow path 201C of the mover 201 do not change. Furthermore, since the diameter φD1 of the inward surface 201E on the radial outer side of the upstream flow path 201C of the mover 201 is set to be smaller than the diameter φD2 of the cylindrical inner diameter 107D of the fixed core 107, and the diameter φD3 of the outward surface 201F on the radial inner side of the upstream flow path 201C of the mover 201 is set to be larger than the diameter φD4 of the outermost surface 133F of the intermediate member 133, the configuration is such that the following Equation (2) is established.

[Mathematical Equation 2]

L22/L12=L21/L11<1 (2)

Here, the radial lengths (L21 and L22) of an overlap between a downstream opening surface of the flow path 107D-133F (magnetic core downstream flow path) and an upstream opening surface of the upstream flow path 201C (mover upstream flow path) are smaller than the radial lengths (L11 and L12) of the flow path 107D-133F (magnetic core downstream flow path). Accordingly, the cross-sectional area of the flow path of the fuel is narrowed.

In the present embodiment, in a valve open state, the entirety of the upstream opening surface of the upstream flow path 201C (mover upstream flow path) overlaps the downstream opening surface of the flow path 107D-133F (magnetic core downstream flow path) in the radial direction. Accordingly, in the valve open state, the position of the upstream flow path 201C (mover upstream flow path) with respect to the flow path 107D-133F (magnetic core downstream flow path) is limited.

In addition, even when the mover 201 moves within the set range (within the range determined by the clearance of each component) in the radial direction, the entirety of the upstream opening surface of the upstream flow path 201C (mover upstream flow path) overlaps the downstream opening surface of the flow path 107D-133F (magnetic core downstream flow path) in the radial direction. Accordingly, even when the mover 201 moves in the radial direction, the area of an overlap between the downstream opening surface of the flow path 107D-133F (magnetic core downstream flow path) and the upstream opening surface of the upstream flow path 201C (mover upstream flow path) does not change.

Incidentally, the radial lengths (L21 and L22) of the upstream flow path 201C (mover upstream flow path) are the radial lengths (L11 and L12) of the flow path 107D-133F (magnetic core downstream flow path) or less. Accordingly, the cross-sectional area of the upstream flow path 201C (mover upstream flow path) is the cross-sectional area of the flow path 107D-133F (magnetic core downstream flow path) or less.

FIG. 6 illustrates a state where the mover 201 lifts the valve body 101, so that the clearance between the lower end surface 107B of the fixed core 107 and the upper end surface 201A of the mover 201 becomes g2″ (g2′>g2″>0) and the axis of the valve body 101 or the mover 201 is misaligned in the rightward direction of the drawing by the amount allowed by the clearance between the components (state where a central axis 201a of the mover 201 is misaligned with respect to the central axis 100a of the fuel injection valve 100 in the rightward direction).

In this state, since in the rightward direction (right portion in FIG. 6) where the axis of the valve body 101 or the mover 201 is misaligned, the intermediate member 133 moves together with the valve body 101 in the rightward direction, the outermost surface 133F approaches the cylindrical inner diameter 107D of the fixed core 107, so that a radial length L11′ of the right flow path of the flow path 107D-133F on the downstream side of the fixed core 107 is smaller than the radial length L11, and on the contrary, since in a leftward direction (left portion in FIG. 6) opposite the axis misalignment, the outermost surface 133F moves away from the cylindrical inner diameter 107D, a radial length L12′ of the left flow path of the flow path 107D-133F is larger than the radial length L12. Since the radial length L21 of the right flow path and the radial length L22 of the left flow path of the upstream flow path 201C of the mover 201 do not change, the following Equation (3) is established.

[Mathematical Equation 3]

L11′<L11,L12<L12′L22/L12′<L22/L12=L21/L11<L21/L11′<1 (3)

In other words, when the mover 201 moves in the radial direction, the ratio of the radial length L21 of the upstream flow path 201C (first mover upstream flow path) formed on a side of a movement direction of the mover 201 to the radial length L11′ of the flow path 107D-133F (first magnetic core downstream flow path) formed on the side of the movement direction of the mover 201 is larger than the ratio of the radial length L22 of the upstream flow path 201C (second mover upstream flow path) formed on a side opposite the movement direction of the mover 201 to the radial length L12′ of the flow path 107D-133F (second magnetic core downstream flow path) formed on the side opposite the movement direction of the mover 201. Accordingly, as will be described later, a differential pressure is generated between the movement direction of the mover 201 and the opposite direction.

Here, when the mover 201 moves in the radial direction, the radial length L12′ of the flow path 107D-133F (second magnetic core downstream flow path) formed on the side opposite the movement direction of the mover 201 is larger than the radial length L11′ of the flow path 107D-133F (first magnetic core downstream flow path) formed on the side of the movement direction of the mover 201. Accordingly, a change in flow rate on the side opposite the movement direction of the mover 201 is larger than a change in flow rate on the side of the movement direction of the mover 201.

For details, the fact that the ratio L21/L11′ of the radial length of the flow path 107D-133F on the downstream side of the fixed core 107 and the radial length of the upstream flow path 201C of the mover 201 in an axis misalignment direction (rightward direction) approaches 1 indicates that a change in fuel flow is decreased in a portion where the flow path 107D-133F on the downstream side of the fixed core 107 is connected to the upstream flow path 201C of the mover 201. Conversely, the fact that the ratio L22/L12′ of the radial length of the flow path 107D-133F on the downstream side of the fixed core 107 and the radial length of the upstream flow path 201C of the mover 201 in a direction (leftward direction) opposite the axis misalignment on one side (rightward direction) is further decreased indicates that the flow path area is narrowed and a change in fuel flow is increased in the portion where the flow path 107D-133F on the downstream side of the fixed core 107 is connected to the upstream flow path 201C of the mover 201.

In general, it is known as Bernoulli's theorem that when the flow path area of a portion is narrowed, the flow speed increases and the pressure decreases in the portion, and the theorem is established between L12′ and L22 of the flow paths in the leftward direction opposite the axis misalignment direction (rightward direction) of FIG. 6.

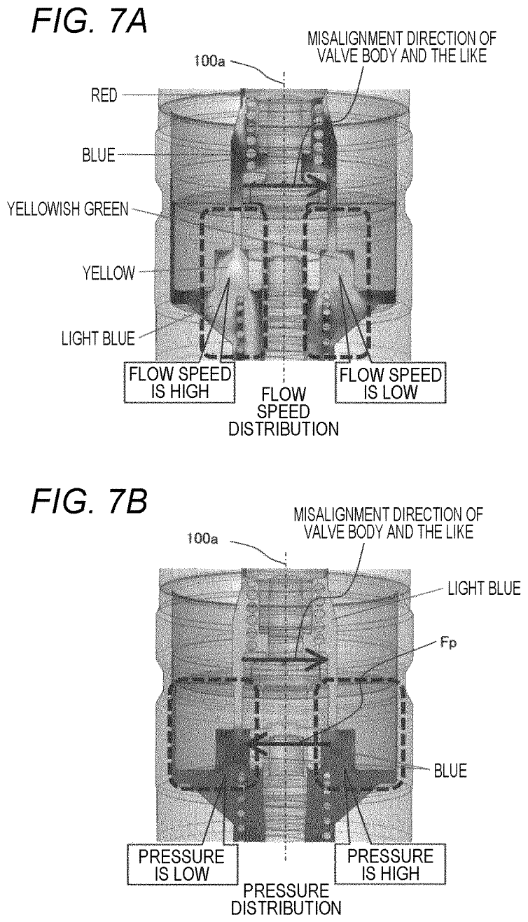

FIGS. 7A and 7B illustrate simulation results when the same state as that of FIG. 6 is simulated using fluid analysis in order to verify the effect.

FIG. 7A illustrates a fluid speed distribution in the vicinity of the mover 201, and FIG. 7B illustrates a pressure distribution. In both illustrations, the closer to blue the color is, the lower the value is, and the closer to read the color is, the higher the value is. In addition, in this simulation, the entire internal flow path of the fuel injection valve is three-dimensionally calculated, a surrounding structure is transparently illustrated, and only a cross section passing through the central axis 100a is illustrated.

In the flow speed distribution of FIG. 7A, when the flow speeds of right and left fuel flow paths (within the frames in the drawing) with respect to the central axis 100a in the vicinity of the mover are compared to each other, the flow speed of the left flow path is high, and the flow speed of the right flow path is low. In addition, in the pressure distribution of FIG. 7B, when the pressures of right and left fuel flow paths (within the frames in the drawing) with respect to the central axis 100a in the vicinity of the mover are compared to each other, it is determined that the pressure of the left flow path is low, and the pressure of the right flow path is high. At this time, due to a difference between the right and left pressures, a differential pressure is applied to the mover 201 from a high pressure side (rightward direction) to a low pressure side (leftward direction).

Namely, a differential pressure Fp is applied in the direction (leftward direction) opposite the axis misalignment direction (rightward direction), so that the effect of correcting an axis misalignment (eccentricity) is exhibited. Namely, fluid force which is applied in a direction to correct the inclination or eccentricity of the valve body (needle) can be used to stabilize the behavior of the valve.

As described above, according to the present embodiment, the eccentricity of the valve body can be corrected. The flow of the fuel flowing through the flow paths provided in the fixed core and the mover can be used to intentionally generate fluid force to be applied in the direction opposite the axis misalignment direction of the mover. Accordingly, the axis misalignment of the mover is decreased, so that the inclination or eccentricity of the valve body can be decreased and the effect of stabilizing the behavior of the valve is exhibited.

### Second Embodiment

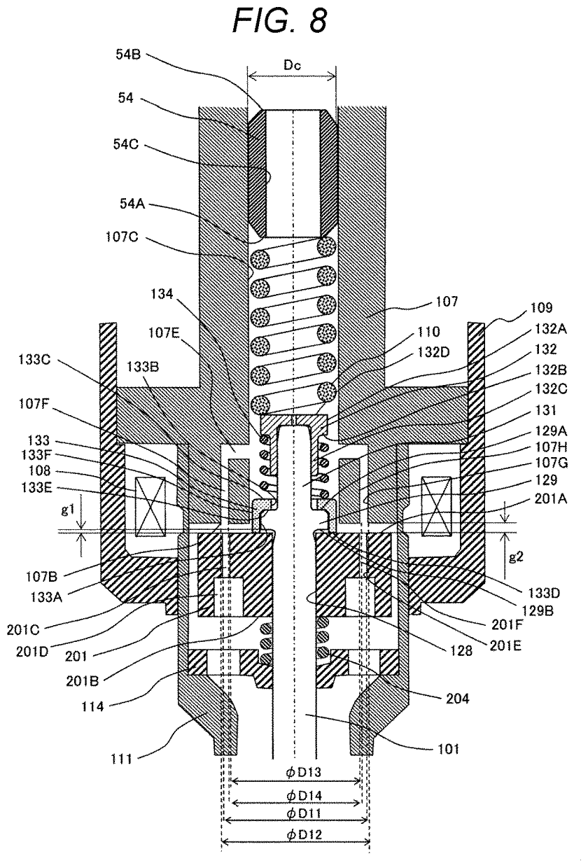

A second embodiment according to the present invention will be described with reference to FIG. 8. FIG. 8 is an enlarged view of the vicinity of the mover 201 of the fuel injection valve 100 according to the second embodiment of the present invention, and is a cross-sectional view illustrating a state where the coil 108 is deenergized. The same configurations or operations as those of the first embodiment are denoted by the same reference signs as those of the first embodiment, and descriptions will be omitted. Incidentally, although not illustrated in FIG. 8, the valve body 101 is in contact with the valve seat 115 provided in the valve seat member 102, so that the valve body 101 is in a valve closed state.

Since the second embodiment is not significantly different from the first embodiment except that the flow paths through which the fuel flows are configured differently, the configuration of the flow paths will be mainly described.

The fuel flowing from upstream of the fixed core 107 flows downstream through the through-hole 107C. A flow path 107F having a groove shape (cylindrical shape) concentric with the central axis 100a is provided in the lower end surface 107B of the fixed core 107 between an outer diameter portion in contact with the nozzle holder 111 and the through-hole 107C.

Namely, the flow path 107F (magnetic core downstream flow path) is formed between the inner peripheral surface of the fixed core 107 (magnetic core) and an outer peripheral surface of the fixed core 107. Accordingly, the weight of the magnetic core 107 is lighter than that of the first embodiment. For details, the flow path 107F (magnetic core downstream flow path) is formed of a recess portion that is formed in an annular shape in the fixed core 107 (magnetic core) and is recessed upstream. Accordingly, the fuel flows rotationally symmetrically with respect to the central axis 100a from the flow path 107F (magnetic core downstream flow path) to the upstream flow path 201C (mover upstream flow path). The flow path 107F is an annular flow path as seen in the axial direction of the central axis 100a.

An upstream portion of the flow path 107F is connected to a plurality of communication holes 107E that are formed in the radial direction to be connected to the through-hole 107C. Namely, the communication hole 107E are formed in the radial direction of the fixed core 107 (magnetic core) to allow the through-hole 107C and the flow path 107F (magnetic core downstream flow path) to communicate with each other. Accordingly, the fuel is bypassed from the through-hole 107C to the flow path 107F.

A clearance is present between the through-hole 107C and the outermost surface 133F of the intermediate member 133, and is sufficiently smaller than the flow path 107F. Accordingly, the fuel flowing from an upstream portion of the through-hole 107C flows downstream mainly through the communication holes 107E and the flow path 107F.

The upstream flow path 201C (annular slit) of the mover 201, which has the same annular shape as that of the first embodiment, is provided in the upper end surface 201A of the mover 201. The upstream flow path 201C of the mover 201 faces the flow path 107F having an annular shape on the downstream side of the fixed core 107. The downstream side of the upstream flow path 201C of the mover 201 is connected to the communication hole 201D, which is provided in the lower end surface 201B of the mover 201, to form a flow path in the mover 201.

A diameter φD11 of the inward surface 201E on the radial outer side of the upstream flow path 201C of the mover 201 is set to be smaller than a diameter φD12 of an inward surface 107G on the radial outer side of the flow path 107F on the downstream side of the fixed core 107, and a diameter φD13 of the outward surface 201F on the radial inner side of the upstream flow path 201C of the mover 201 is set to be smaller than a diameter φD14 of an outward surface 107H on the radial inner side of the flow path 107F on the downstream side of the fixed core 107. In FIG. 8, the flow path width in the radial direction of the flow path 107F on the downstream side of the fixed core 107 and the flow path width in the radial direction of the upstream flow path 201C of the mover 201 are equal, but may differ from each other.

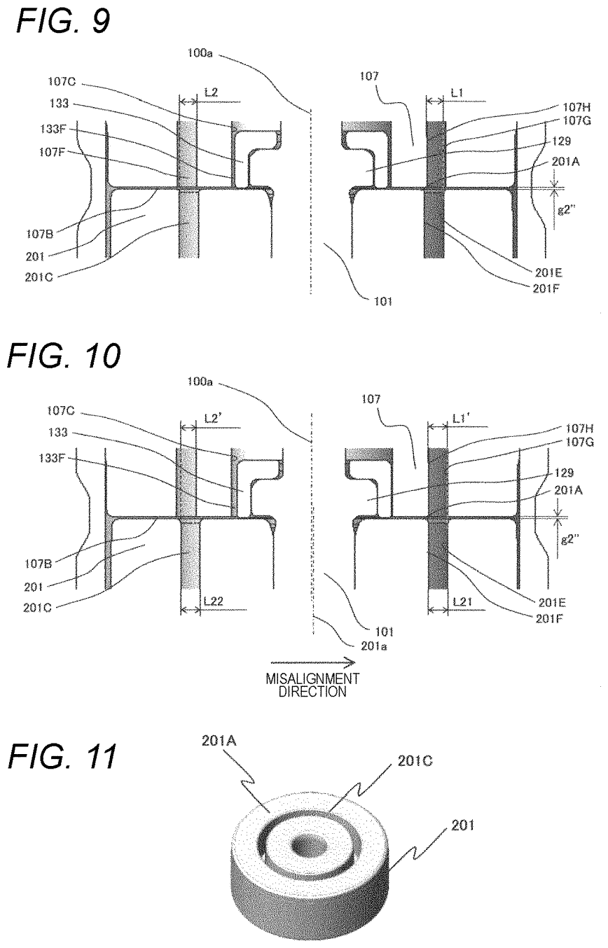

Here, FIGS. 9 and 10 illustrate enlarged cross-sectional views of the downstream side of the fixed core 107, the upstream side of the mover 201, and the vicinity of the valve body 101.

FIG. 9 illustrates a positional relationship between the components when the mover 201 lifts the valve body 101, so that the clearance between the lower end surface 107B of the fixed core 107 and the upper end surface 201A of the mover 201 becomes g2″ (g2−g1>g2″>0), and an axis misalignment does not occur.

In this state, the positional relationship between the flow path 107F on the downstream side of the fixed core 107 and the upstream flow path 201C of the mover 201 is bilaterally symmetrical with respect to the central axis 100a. Namely, the inward surface 201E on the radial outer side of the upstream flow path 201C of the mover 201 is located closer to a center side than the inward surface 107G on the radial outer side of the flow path 107F on the downstream side of the fixed core, and the outward surface 201F on the radial inner side of the upstream flow path 201C of the mover 201 is located closer to the center side than the outward surface 107H on the radial inner side of the flow path 107F on the downstream side of the fixed core 107.

Accordingly, when the fuel flows from the flow path 107F on the downstream side of the fixed core 107 to the upstream flow path 201C of the mover 201, a flow path in a connection portion therebetween is narrowed by the outward surface 107H on the radial inner side of the flow path 107F on the downstream side of the fixed core 107 and the inward surface 201E on the radial outer side of the upstream flow path 201C of the mover 201. In this case, the radial widths of the portion where the flow path is narrowed are represented by a flow path width L1 on the right side and a flow path width L2 on the left side, and in the state of FIG. 9, since the positional relationship is bilaterally symmetrical, L1=L2 is established.

FIG. 10 illustrates a state where the mover 201 lifts the valve body 101, so that the clearance between the lower end surface 107B of the fixed core 107 and the upper end surface 201A of the mover 201 becomes g2″ (g2−g1>g2″>0) and the axis of the valve body 101 or the mover 201 is misaligned in the rightward direction of the drawing by the amount allowed by the clearance between the components (state where the central axis 201a of the mover 201 is misaligned with respect to the central axis 100a of the fuel injection valve 100 in the rightward direction).

In this state, the positional relationship between the flow path 107F on the downstream side of the fixed core 107 and the upstream flow path 201C of the mover 201 is bilaterally asymmetrical with respect to the central axis 100a. Namely, since in the axis misalignment direction (rightward direction), the inward surface 201E on the radial outer side of the upstream flow path 201C of the mover 201 approaches the inward surface 107G on the radial outer side of the flow path 107F on the downstream side of the fixed core 107 in the radial direction, and moves away from the outward surface 107H on the radial inner side of the flow path 107F on the downstream side of the fixed core 107, a flow path width L1′ (distance between the outward surface 107H and the inward surface 201E) of a portion where the flow path is narrowed is larger than L1 of FIG. 9. In addition, since in the direction (leftward direction) opposite the axis misalignment, the inward surface 201E of the upstream flow path 201C of the mover 201 moves away from the inward surface 107G of the flow path 107F on the downstream side of the fixed core 107 in the radial direction, and approaches the outward surface 107H of the flow path 107F on the downstream side of the fixed core 107, a flow path width L2′ of a portion where the flow path is narrowed is smaller than L2 of FIG. 9.

Accordingly, due to Bernoulli's theorem, the flow speed increases and the pressure decreases in a flow path connection portion between the flow path 107F on the downstream side of the fixed core 107 and the upstream flow path 201C of the mover 201 in the direction (leftward direction) opposite the axis misalignment. Then, due to a pressure difference between the right and left flow paths, a differential pressure is applied in the direction (leftward direction) opposite the axis misalignment, so that the effect of correcting an axis misalignment (eccentricity) is exhibited.

Namely, fluid force which is applied in a direction to correct the inclination or eccentricity of the valve body (needle) can be used to stabilize the behavior of the valve.

As described above, according to the present embodiment, the eccentricity of the valve body can be corrected.

Incidentally, the present invention is not limited to the above embodiments, and include various modification examples. For example, the above embodiments have been described in detail in order to facilitate understanding of the present invention, and are not necessarily limited to including all the configurations. In addition, a part of a configuration of an embodiment can be substituted by a configuration of another embodiment, and a configuration of another embodiment can be added to a configuration of an embodiment. In addition, the addition, removal, or substitution of another configuration can be made to a part of the configuration of each of the embodiments.

In the present embodiments, the intermediate member 133 is used for a preliminary lift, but may not be used.

In the example of FIG. 12, the number of the communication holes 201D is 4; however, the number is random. Incidentally, it is desirable that the intervals in a circumferential direction of the communication holes 201D are equal to correct an eccentricity of the mover 201.

### REFERENCE SIGNS LIST

54 adjuster
101 valve body
102 valve seat member
107 fixed core
110 first spring (valve closing spring)
115 valve seat
116 fuel injection hole
132 cap
133 intermediate member
103 second spring (intermediate spring)
204 third spring (zero spring)
112 fuel supply port
201 mover

1. A fuel injection valve comprising:
a valve body;
a mover that drives the valve body;
a magnetic core that attracts the mover; and
a magnetic core downstream flow path representing a flow path that is formed on a downstream side of the magnetic core,
wherein the mover includes
a mover upstream flow path representing a flow path that is connected to the magnetic core downstream flow path to allow fuel to flow downstream, and
a radial length of an overlap between a downstream opening surface of the magnetic core downstream flow path and an upstream opening surface of the mover upstream flow path is smaller than a radial length of the magnetic core downstream flow path.

2. The fuel injection valve according to claim 1,
wherein when the mover moves in a radial direction, a ratio of a radial length L21 of a first mover upstream flow path formed on a side of a movement direction of the mover to a radial length L11′ of a first magnetic core downstream flow path formed on the side of the movement direction of the mover is larger than a ratio of a radial length L22 of a second mover upstream flow path formed on a side opposite the movement direction of the mover to a radial length L12′ of a second magnetic core downstream flow path formed on the side opposite the movement direction of the mover.

3. The fuel injection valve according to claim 1,
wherein the mover is provided with a mover downstream flow path that is connected to a downstream opening surface of the mover upstream flow path and has an upstream opening surface having a larger cross-sectional area than a cross-sectional area of the downstream opening surface of the mover upstream flow path.

4. The fuel injection valve according to claim 1,
wherein the mover upstream flow path is formed of a recess portion that is formed in an annular shape in the mover and is recessed downstream.

5. The fuel injection valve according to claim 3,
wherein a plurality of the mover downstream flow paths are formed in a cylindrical shape in the mover.

6. The fuel injection valve according to claim 1,
wherein in a valve open state, an entirety of the upstream opening surface of the mover upstream flow path overlaps the downstream opening surface of the magnetic core downstream flow path in a radial direction.

7. The fuel injection valve according to claim 2,
wherein the magnetic core downstream flow path is formed between an outer diameter portion of the valve body and an inner diameter portion of the magnetic core, and
when the mover moves in the radial direction, the radial length L12′ of the second magnetic core downstream flow path formed on the side opposite the movement direction of the mover is larger than the radial length L11′ of the first magnetic core downstream flow path formed on the side of the movement direction of the mover.

8. The fuel injection valve according to claim 6,
wherein when the mover moves within a set range in the radial direction,
the entirety of the upstream opening surface of the mover upstream flow path overlaps the downstream opening surface of the magnetic core downstream flow path in the radial direction.

9. The fuel injection valve according to claim 1,
wherein the valve body includes a flange portion that engages with the mover, and
the magnetic core downstream flow path is formed between the flange portion and the magnetic core.

10. The fuel injection valve according to claim 9, further comprising:
an intermediate member that forms a gap between the flange portion and the mover in a valve closed state,
wherein the magnetic core downstream flow path is formed between an outer peripheral surface of the intermediate member and an inner peripheral surface of the magnetic core.

11. The fuel injection valve according to claim 10,
wherein an inner diameter on the downstream side of the magnetic core is larger than an inner diameter on an upstream side of the magnetic core.

12. The fuel injection valve according to claim 10,
wherein a radial length of the mover upstream flow path is the radial length of the magnetic core downstream flow path or less.

13. The fuel injection valve according to claim 1,
wherein the magnetic core downstream flow path is formed between an inner peripheral surface of the magnetic core and an outer peripheral surface of the magnetic core.

14. The fuel injection valve according to claim 13,
wherein the magnetic core downstream flow path is formed of a recess portion that is formed in an annular shape in the magnetic core and is recessed upstream.

15. The fuel injection valve according to claim 14,
wherein the magnetic core includes
a through-hole that is formed in a central axis direction of the magnetic core, and
a communication hole that is formed in a radial direction of the magnetic core to allow the through-hole and the magnetic core downstream flow path to communicate with each other.
